(19) United States
(12) Patent Application Publication
(10) Pub. No.: US 2024/0191700 A1
(43) Pub. Date: Jun. 13, 2024

(54) ELECTRIC GENERATOR

(71) Applicant: Rodney Clugston, Port McNicoll (CA)

(72) Inventor: Rodney Clugston, Port McNicoll (CA)

(21) Appl. No.: 18/538,966

(22) Filed: Dec. 13, 2023

Related U.S. Application Data
(60) Provisional application No. 63/432,253, filed on Dec. 13, 2022.

(51) Int. Cl. F03G 3/08; F03G 3/00

(52) U.S. Cl. CPC F03G 3/08; F03G 3/087; F05B 2260/421; F05B 2260/505; F05B 2270/604; F05B 2270/80

(57) ABSTRACT

The present specification relates generally to generators and more specifically to an environmentally friendly device and method for generating electricity without a fuel source. The device, an electric generator, comprises an outer chamber filled with a first quantity of water; a lower bellows assembly, immediately below the outer chamber, filled with a second quantity of water; a support bracket fixed within the outer chamber comprising at least one post extending from a top face thereof and at least one lower electromagnet; a chain assembly; a flywheel; a generator; an inner chamber disposed within the outer chamber and having at a bottom end at least one flapper valve and at least one upper electromagnet; at least one return pipe having a first end in connection with the lower bellows assembly and a second end proximate the inner chamber; and a series of valves.

### FIELD OF THE INVENTION

The present specification relates generally to generators and more specifically to an environmentally friendly device and method for generating electricity without a fuel source.

### BACKGROUND OF THE INVENTION

Generators, whether portable generators intended to supply power during an outage, or massive scale generators housed within power plants which otherwise supply power to today's electrical grids, play a key role in our day-to-day lives. Despite the prevalence of their use, generators today almost all depend on a non-renewable fuel source to generate the mechanical energy which is then converted into electrical energy by the generator. Depending on the particular generator, this fuel source may be any one or more of: gasoline, diesel fuel, propane, or natural gas. Consequently, while generators are an indispensable asset, they are also a significant source of air pollution and can be dangerous to human health if operated indoors. It is well established that the use of these generators indoors can result in death in a matter of minutes from carbon monoxide poisoning resulting from the carbon monoxide emitted by these devices.

Further, while solar generators are an available alternative to diesel, gasoline, and propane fueled generators, the power output of these generators pales in comparison to that of their less environmentally friendly counterparts and, perhaps more importantly, these generators are slaves to the weather. Consequently, solar generators cannot be relied on in exclusivity and cannot replace generators fueled with gasoline, diesel fuel, propane, and/or natural gas.

Accordingly, there remains a need for improvements in the art.

### SUMMARY OF THE INVENTION

In an embodiment of the present invention, there is provided an electric generator comprising: an outer chamber filled with a first quantity of water; a lower bellows assembly, immediately below the outer chamber, filled with a second quantity of water; a support bracket fixed within the outer chamber comprising at least one post extending from a top face thereof and at least one lower electromagnet; a chain assembly, comprising a chain, a chain brake, at least one pulley, and a counterweight, disposed at a first end of the chain; a flywheel contiguous with the chain, disposed between the counterweight and the at least one pulley; a generator contiguous with the chain and fixed to the flywheel; an inner chamber disposed within the outer chamber, connected at a top end to a second end of the chain and having at a bottom end at least one flapper valve and at least one upper electromagnet; at least one return pipe having a first end in connection with the lower bellows assembly and a second end proximate the inner chamber; a series of valves comprising: at least one bleeder valve connecting the outer chamber with the at least one return pipe; at least one pipe valve disposed within the at least one return pipe; at least one check valve disposed within the at least one return pipe; and at least one one-way valve between the outer chamber and the lower bellows assembly, configured to open in the direction of the lower bellows assembly.

Other aspects and features according to the present application will become apparent to those ordinarily skilled in the art upon review of the following description of embodiments of the invention in conjunction with the accompanying figures.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 is a front plan view of an electric generator in a second configuration, according to an embodiment;

FIG. 2 is right-side plan view of an electric generator in a first configuration, according to an embodiment;

FIG. 3 is a cross-sectional view of the electric generator of FIG. 2 taken along the line I-I;

FIG. 4A is a partial cross-sectional view of the electric generator of FIG. 2 taken along the line I-I;

FIG. 4B is partial cross-sectional view of the electric generator of FIG. 2 taken along the line I-I;

FIG. 5A is a partial cross-sectional view of the electric generator of FIG. 2, in a second configuration, taken along the line I-I;

FIG. 5B is a partial cross-sectional view of the electric generator of FIG. 2, in a second configuration, taken along the line I-I;

FIG. 6A is a partial cross-sectional view of the electric generator of FIG. 2, in a third configuration, taken along the line I-I;

FIG. 6B is a partial cross-sectional view of the electric generator of FIG. 2, in a third configuration, taken along the line I-I;

FIG. 7A is a partial cross-sectional view of the electric generator of FIG. 2, in a fourth configuration, taken along the line I-I;

FIG. 7B is a partial cross-sectional view of the electric generator of FIG. 2, in a fourth configuration, taken along the line I-I; and

FIG. 8 is a left-side perspective view of an electric generator, according to an embodiment.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and, in some instances, proportions may have been exaggerated in order more clearly to depict certain features of the invention.

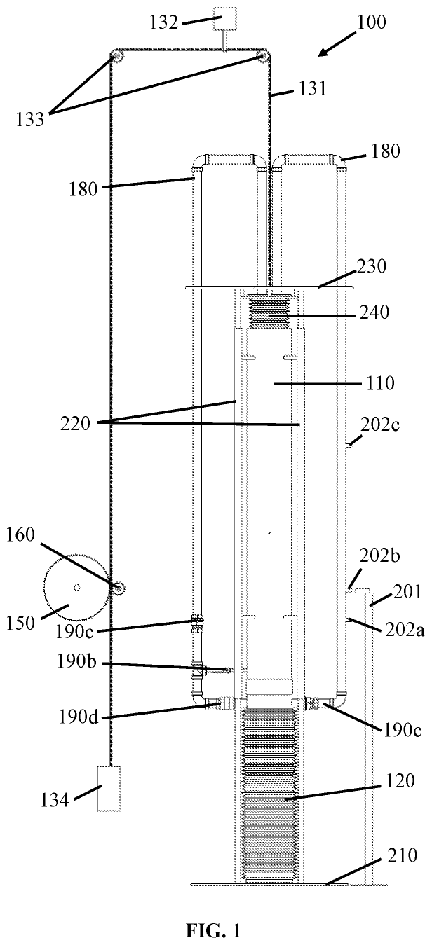

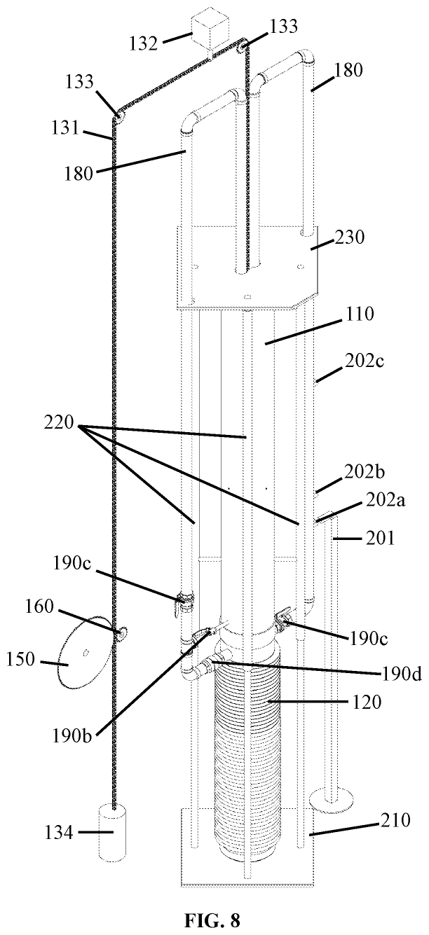

According to an embodiment, as shown in FIGS. 1-3 and 8, an electric generator 100 is provided to enable the generation of electricity without a fuel source. Accordingly, electric generator 100 may reduce the environmental impact of electricity generation and reduce the costs associated with same. Being emission free, electric generator 100 may improve the safety of electricity generation and reduce the likelihood of illness or death resulting from or related to electricity generation. Additionally, electric generator 100 may provide an all-weather eco alternative to the use of solar generators and thereby improve access to eco-friendly electricity generation at any given time of day and in any given season.

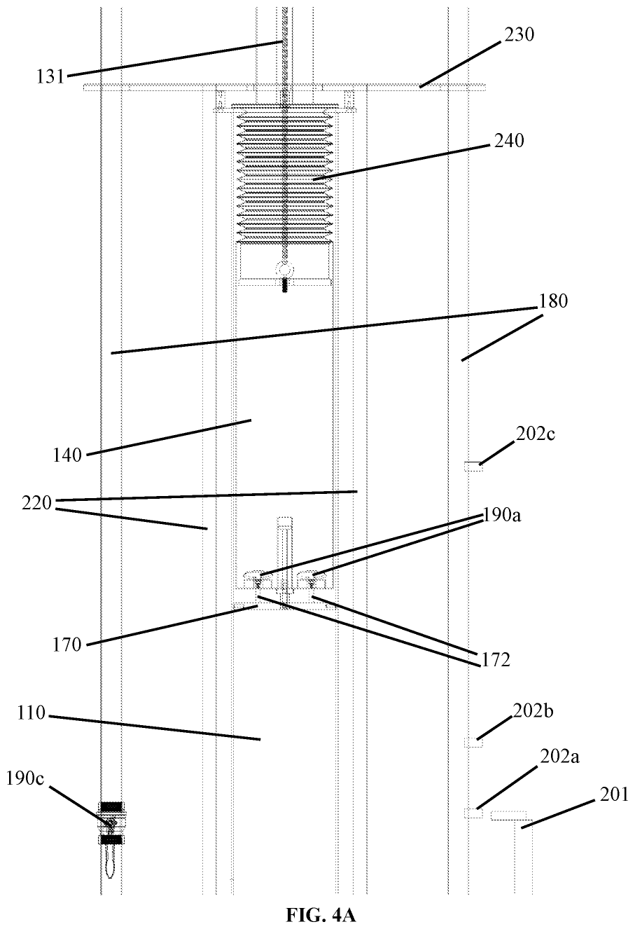

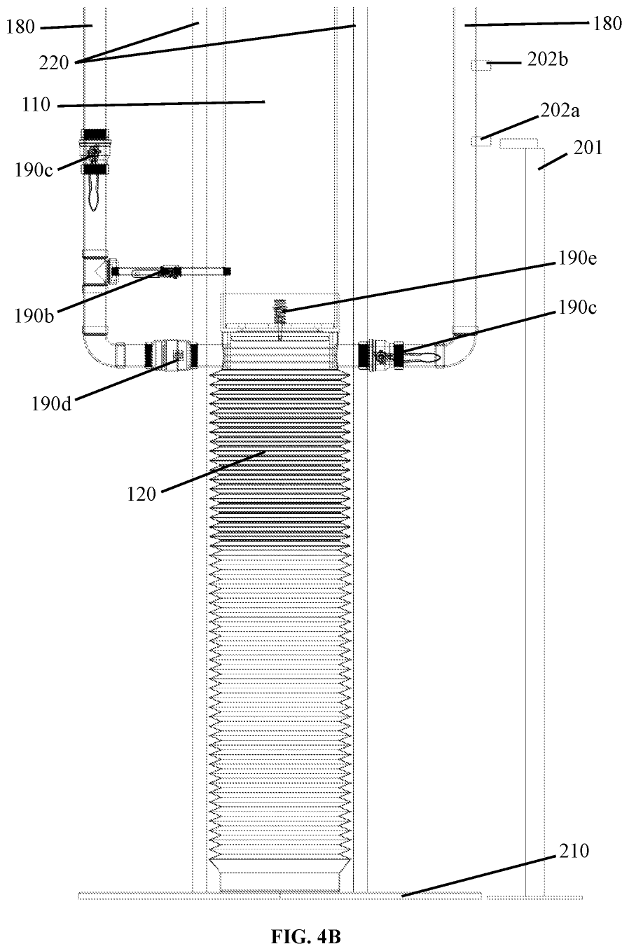

As shown in FIGS. 1-8, electric generator 100 comprises an outer chamber 110 filled with a first quantity of water (not shown). According to an embodiment, the first quantity of water is 75 litres. According to an embodiment, outer chamber 110 has a capacity of approximately 170 litres. As shown in FIGS. 1-3, 4B, 5B, 6B, 7B and 8, outer chamber 110 is disposed immediately above a lower bellows assembly 120 of electric generator 100. A size and shape of outer chamber 110 may vary. According to an embodiment, outer chamber 110 is approximately 12 inches in diameter and approximately 98 inches long. According to an embodiment, outer chamber 110 and lower bellows assembly 120 are equivalent in diameter. Outer chamber 110 may be an open-top hollow cylinder. Outer chamber 110 may be constructed of one or a combination of aluminum, thermoplastic, tin, steel, and rubber.

Lower bellows assembly 120 is filled with a second quantity of water (not shown). According to an embodiment, the second quantity of water is 104 litres. According to an embodiment, lower bellows assembly 120 has a capacity of approximately 104 litres. A size and shape of lower bellows assembly 120 may vary. Lower bellows assembly 120 may be an open-top hollow cylinder. Lower bellows assembly 120 may be constructed of one or a combination of aluminum, thermoplastic, tin, steel, and rubber.

As shown in FIGS. 1, 3 and 8, electric generator 100 further comprises a chain assembly comprising a chain 131, a chain brake 132, at least one pulley 133 and a counterweight 134 disposed at a first end of chain 131. At least one pulley 133 may comprise two pulleys, as shown in FIGS. 1, 3 and 8. Chain assembly 130 serves to control the movement of an inner chamber 140 of electric generator 100 and translate the movement of inner chamber 140 to a flywheel 150 and a generator 160, each contiguous with chain 131 and each other. Generator 160 is fixed to flywheel 150. When chain 131 moves, flywheel 150 and generator 160 spin. When chain 131 comes to a stop, flywheel 150 continues spinning and transfers that spinning motion to generator 160, prolonging the period of time over which the generator is working. A length of chain 131 may vary. According to an embodiment, chain 131 is at least 84 inches long. A position of chain brake 132 along chain 131 and relative to at least one pulley 133 may vary. According to an embodiment, chain brake 132 is disposed at a point along chain 131 between inner chamber 140 and flywheel 150 and generator 160, as shown in FIGS. 1, 3 and 8. Counterweight 134 may be constructed of one or a combination of steel, rubber and lead. Counterweight 134 has a weight sufficient to maintain tension on chain 131. According to an embodiment, counterweight 134 has a weight of between 2 and 5 pounds.

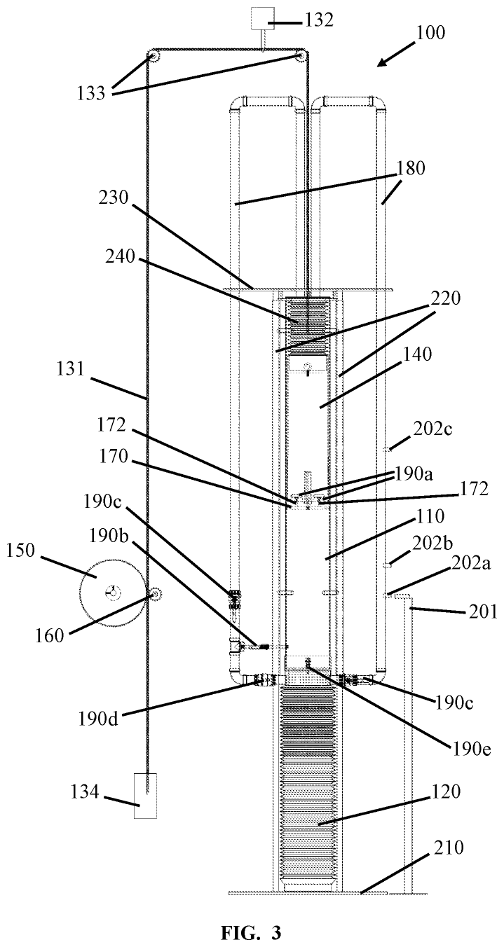

As shown in FIGS. 3, 4A, 5A, 6A, 7A and 7B, electric generator 100 further comprises inner chamber 140, disposed within outer chamber 110, connected at a top end to a second end of chain 131 and having at a bottom end at least one flapper valve 190a and at least one upper electromagnet (not shown). A size and shape of inner chamber 140 may vary. According to an embodiment, inner chamber 110 is approximately 11 inches in diameter and approximately 33 inches long. Inner chamber 140 may be an open-top hollow cylinder. Inner chamber 140 may be constructed of one or a combination of aluminum, thermoplastic, tin, steel, and rubber. According to an embodiment, at least one flapper valve 190a comprises two flapper valves, as shown in FIGS. FIGS. 3, 4A, 5A, 6A, 6B, 7A and 7B. A size and shape of at least one flapper valve 190a may vary. According to an embodiment, the at least one upper electromagnet is disposed at a centre point of the bottom end of inner chamber 140. The at least one upper electromagnet has a magnetic strength sufficient to lift outer chamber 110.

As shown in FIGS. 3, 4A, 5A, 5B, and 6B—7B, electric generator 100 further comprises a support bracket 170 fixed within outer chamber 110 comprising at least one post 172 extending from a top face of support bracket 170 and at least one lower electromagnet (not shown). A size and shape of at least one post 172 and the at least one lower electromagnet may vary. According to an embodiment, at least one post 172 is 7.5 cm tall. At least one post 172 serves to open at least one flapper valve 190a when inner chamber 140 rests on support bracket 170. A size of at least one post 172 may correspond to a size of at least one flapper valve 190a. At least one post 172 may comprise two posts, as shown in FIGS. 3, 4A, 5A, 5B, and 6B—7B. The at least one lower electromagnet serves to engage the at least one upper electromagnet thereby removably connecting inner chamber 140 with outer chamber 110. A position of the at least one lower electromagnet along support bracket 170 may vary. According to an embodiment, the at least one lower electromagnet is disposed at a centre point of support bracket 170. According to an embodiment, support bracket 170 is fixed within outer chamber 110 at a point halfway along a height of outer chamber 110, as shown in FIG. 3.

Electric generator 100 further comprises at least one return pipe 180 having a first end in connection with lower bellows assembly 120 and a second end proximate inner chamber 140, as shown in FIGS. 1-3 and 8. A length, shape and diameter of return pipe 180 may vary. According to an embodiment, at least one return pipe has a diameter of 5 cm. At least one return pipe 180 may comprise two return pipes disposed on opposite sides of outer chamber 110, as shown in FIGS. 1-8. According to an embodiment, at least one return pipe 180 is supported by attachment to outer chamber 110, as shown in FIGS. 1-8. Second end of return pipe 180 is configured such that return pipe 180 empties into inner chamber 140.

As shown in FIG. 3, electric generator 100 further comprises a series of valves 190. Series of valves 190 may be connected to and controlled by a computer. Alternatively, series of valves 190 may be manually operated. Series of valves 190 comprises flapper valve 190a, at least one bleeder valve 190b connecting outer chamber 110 with at least one return pipe 180, at least one pipe valve 190c disposed within at least one return pipe 180, at least one check valve 190d disposed within at least one return pipe 180, and at least one one-way valve 190e between outer chamber 110 and lower bellows assembly 120, configured to open in the direction of lower bellows assembly 120.

According to an embodiment, electric generator 100 further comprises a sensor system, wherein the sensor system comprises at least one target 202 and a sensor 201 configured to detect proximity of sensor 201 to at least one target 202, as shown in FIGS. 1, 3-5B, and 6B—8. According to an embodiment, at least one target 202 comprises a first target 202a, disposed along an outer wall of outer chamber 110, a second target 202b disposed along the outer wall at a point above first target 202a, and a third target 202c disposed along the outer wall at a point above second target 202b, as shown in FIGS. 1, 3, 4A, 5A, 6B, 7B and 8.

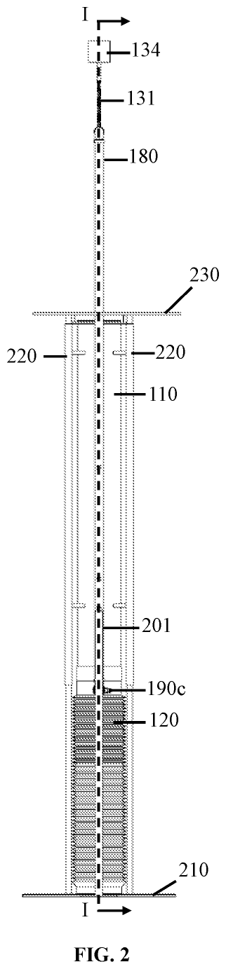

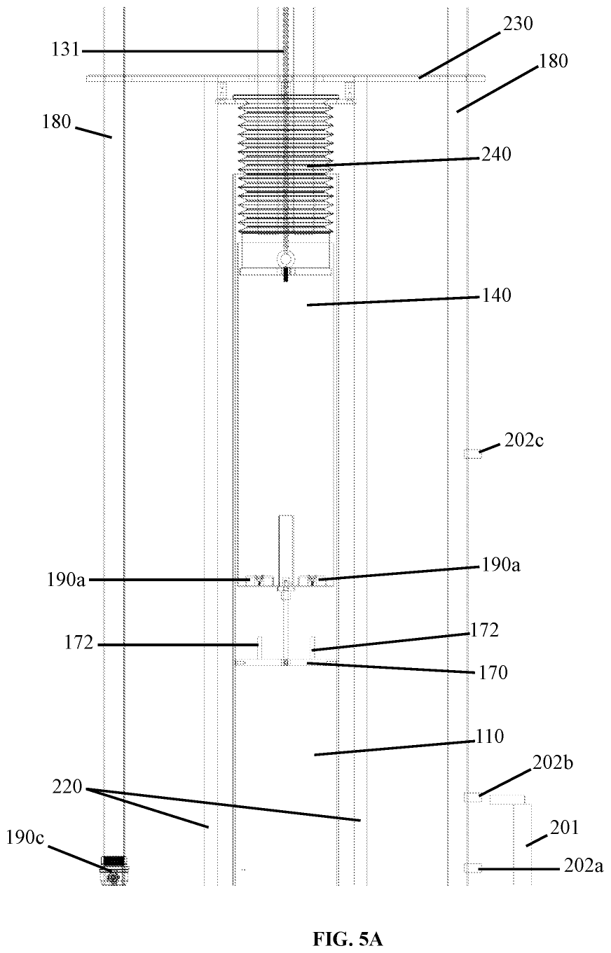

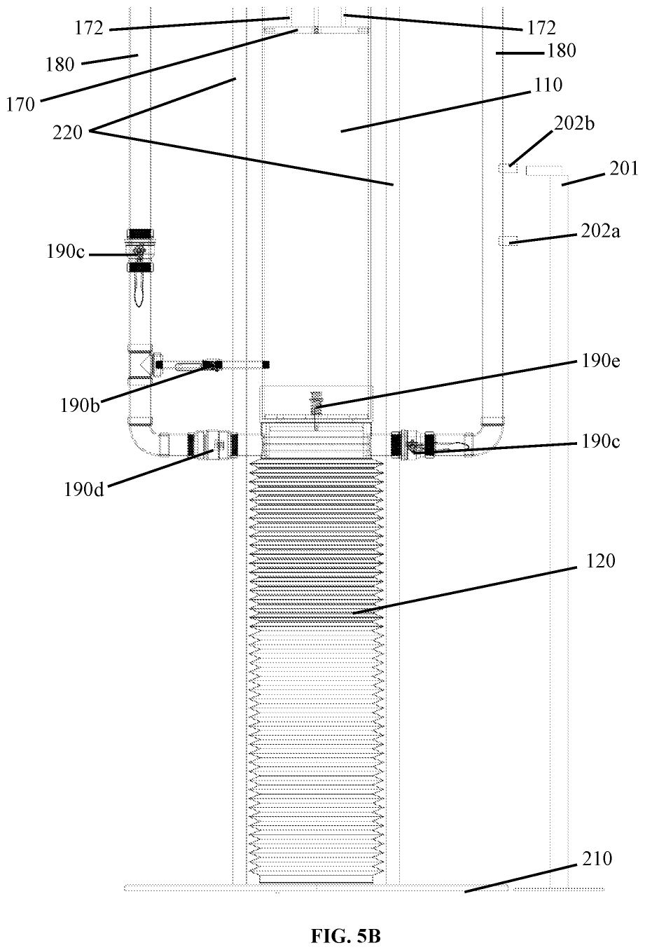

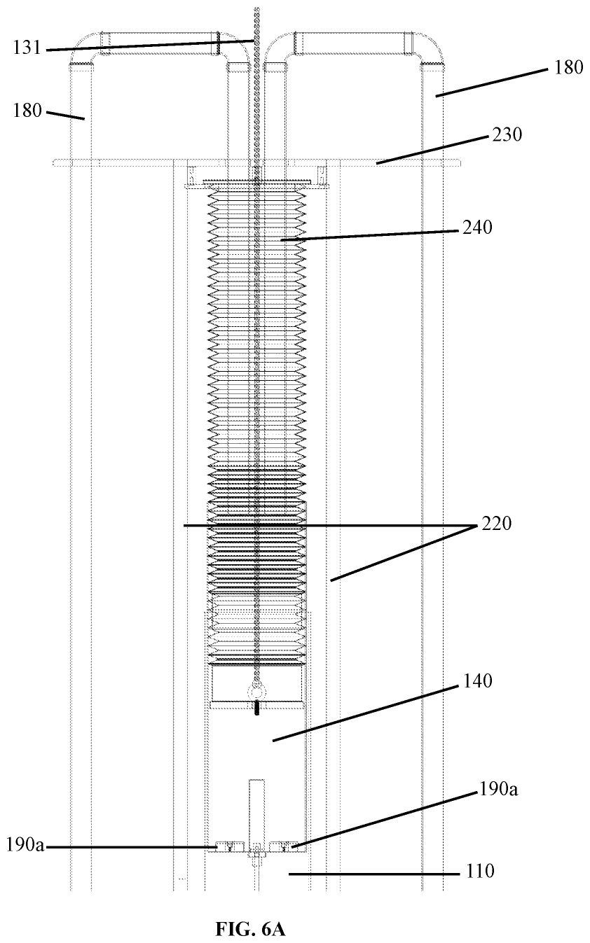

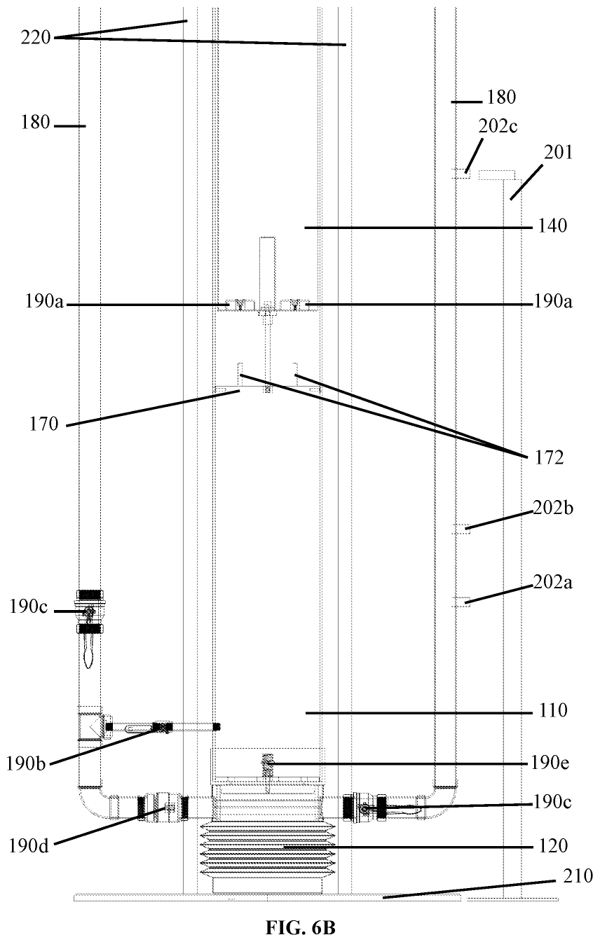

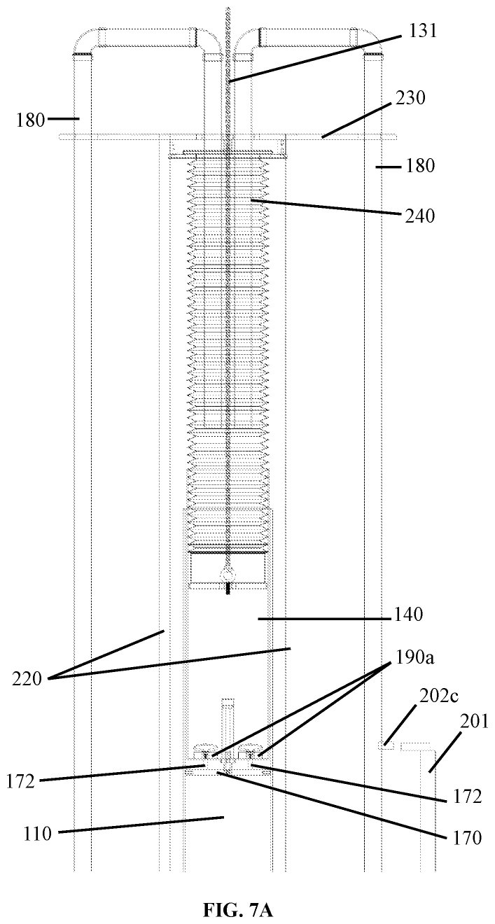

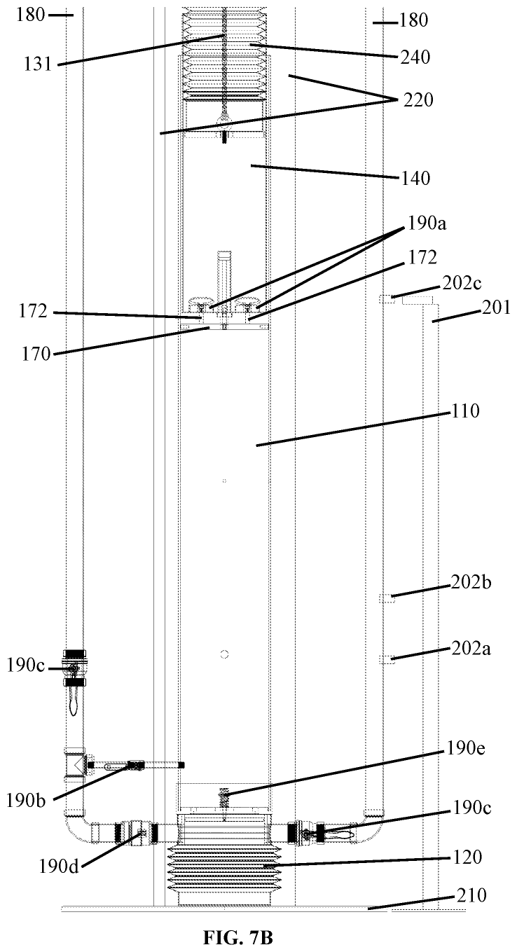

According to an embodiment, when sensor 201 detects first target 202a, at least one pipe valve 190c opens and each of the at least one lower electromagnet and the at least one upper electromagnet are demagnetized. As a result, inner chamber 140 is disconnected from support bracket 170 of outer chamber 110. Electric generator 100 is now in a first configuration, as shown in FIGS. 2-4B. With at least one pipe valve 190c open, the weight of the first quantity of water in outer chamber 110 compresses lower bellows assembly 120 and, as it does so, the second quantity of water in lower bellows assembly 120 begins to flow into at least one return pipe 180. At the top end of at least one return pipe 180 the second quantity of water flows out of return pipe 180 and into inner chamber 140. Inner chamber 140 is stationary and prevented from moving under the weight of the second quantity of water by chain 131 and chain brake 132. Electric generator 100 is now in a second configuration, as shown in FIGS. 5A and 5B. When outer chamber 110 descends, sensor 201 detects second target 202b. At this point, inner chamber 140 is no longer in contact with the first quantity of water within outer chamber 110 but is suspended above the first quantity of water. The detection of second target 202b by sensor 201 triggers the release of chain brake 132. As a result, inner chamber 140 begins to descend under the weight of the second quantity of water, pulling chain 131. As chain 131 is pulled past flywheel 150 and generator 160, flywheel 150 and generator 160 spin. Generator 160 converts this mechanical energy into electrical energy. The electrical energy is stored in a battery (not shown) and serves to power the sensor system, the at least one lower electromagnet and the at least one upper electromagnet. When outer chamber 110 has fully compressed lower bellows assembly 120, sensor 201 detects third target 202c, triggering the closure of at least one pipe valve 190c, and the magnetization of the at least one lower electromagnet and the at least one upper electromagnet. Inner chamber 140 is still descending. Electric generator 100 is now in a third configuration, as shown in FIGS. 6A and 6B. When inner chamber 140 reaches the end of its downward stroke, it contacts support bracket 170 and at least one post 172 on support bracket 170 pushes open at least one flapper valve 190a on inner chamber 140. With at least one flapper valve 190a open, the second quantity of water in inner chamber 140 drains into outer chamber 110, while the at least one lower electromagnet and the at least one upper electromagnet secure inner chamber 140 and outer chamber 110 together. The engagement of the at least one lower electromagnet and the at least one upper electromagnet triggers the opening of at least one bleeder valve 190b. Electric generator 100 is now in a fourth configuration, as shown in FIGS. 7A and 7B. As outer chamber 110 fills with the second quantity of water and inner chamber 140 empties, inner chamber 140 floats and ascends in outer chamber 110 as counterweight 134 pulls chain 131. With at least one bleeder valve 190b open, the pressure between lower bellows assembly 120 and outer chamber 110 equalizes. As inner chamber 140 ascends, it pulls outer chamber 110 with it, which in turn pulls and expands lower bellows assembly 120 which fills with water flowing from outer chamber 110 into lower bellows assembly 120 through at least one one-way valve 190e. When lower bellows assembly 120 has returned to its initial position, a spring on at least one one-way valve 190e causes it to close. When inner chamber 140 and outer chamber 110 have returned to their initial positions, sensor 201 detects target 202a, electric generator 100 has returned to the first configuration, and the cycle repeats.

According to an embodiment, electric generator 100 further comprises a battery (not shown) in connection with generator 160, the at least one upper electromagnet, the at least one lower electromagnet, and sensor system 200. The battery may be charged by generator 160 and may power the at least one upper electromagnet, the at least one lower electromagnet, and sensor system 200.

According to an embodiment, electric generator 100 further comprises a base 210 and at least one slide rail 220 in connection with base 210 and at least one outer chamber 110, configured to support and move with outer chamber 110, as shown in FIGS. 1, 3, 4B, 5B, 6B and 7B. According to a further embodiment, as shown in FIGS. 1, 3, 4A, 5A, 6A and 7A, electric generator further comprises a support plate 230 disposed above inner chamber 140 at a top end of at least one slide rail 220, and an upper bellows assembly 240, affixed at a top end to support plate 230 and at a bottom end to inner chamber 140. Support plate 230 may provide support to one or more of at least one slide rail 220 and at least one return pipe 180. According to an embodiment, upper bellows assembly 240 is equivalent in diameter to inner chamber 140. According to an embodiment, upper bellows assembly 240 has a diameter of 11″. According to an embodiment, as inner chamber 140 descends, it pulls on upper bellows assembly 240, anchored to support plate 230, which stretches and expands, and as inner chamber 140 ascends, upper bellows assembly 240 collapses.

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

What is claimed is:

1. An electric generator, comprising:
an outer chamber filled with a first quantity of water;
a lower bellows assembly, immediately below the outer chamber, filled with a second quantity of water;
a support bracket fixed within the outer chamber comprising at least one post extending from a top face thereof and at least one lower electromagnet;
a chain assembly, comprising:
a chain;
a chain brake;
at least one pulley; and
a counterweight, disposed at a first end of the chain;
a flywheel contiguous with the chain, disposed between the counterweight and the at least one pulley;
a generator contiguous with the chain and fixed to the flywheel;
an inner chamber disposed within the outer chamber, connected at a top end to a second end of the chain and having at a bottom end at least one flapper valve and at least one upper electromagnet;
at least one return pipe having a first end in connection with the lower bellows assembly and a second end proximate the inner chamber;
a series of valves comprising:
at least one bleeder valve connecting the outer chamber with the at least one return pipe;
at least one pipe valve disposed within the at least one return pipe;
at least one check valve disposed within the at least one return pipe; and
at least one one-way valve between the outer chamber and the lower bellows assembly, configured to open in the direction of the lower bellows assembly.

2. The electric generator of claim 1, further comprising a sensor system, wherein the sensor system comprises at least one target and a sensor configured to detect proximity to the sensor of the at least one target.

3. The electric generator of claim 2, wherein the at least one target comprises a first target, disposed along an outer wall of the outer chamber, a second target disposed along the outer wall at a point above the first target, and a third target disposed along the outer wall at a point above the second target.

4. The electric generator of claim 2, further comprising a battery in connection with the generator, the at least one upper electromagnet, the at least one lower electromagnet, and the sensor system.

5. The electric generator of claim 1, further comprising a base, and at least one slide rail in connection with the base and the at least one outer chamber, configured to support and move with the outer chamber.

6. The electric generator of claim 5, further comprising:
a support plate disposed above the inner chamber at a top end of the at least one slide rail;
an upper bellows assembly, affixed at a top end to the support plate and at a bottom end to the inner chamber.

7. The electric generator of claim 1, wherein the chain brake is disposed at a point along the chain between the inner chamber and the flywheel and generator.

8. The electric generator of claim 1, wherein the at least one return pipe comprises two return pipes and the at least one pulley comprises two pulleys.

9. The electric generator of claim 1, wherein the inner chamber and upper bellows assembly are equivalent in diameter.

10. The electric generator of claim 9, wherein the inner chamber and upper bellows assembly have a diameter of 11″.

11. The electric generator of claim 1, wherein the outer chamber and lower bellows assembly are equivalent in diameter.

12. The electric generator of claim 11, wherein the outer chamber and lower bellows assembly have a diameter of 12″.

13. The electric generator of claim 1, wherein the at least one post comprises two posts and the at least one flapper valve comprises two flapper valves.

14. The electric generator of claim 1, wherein the support bracket is fixed within the outer chamber at a point halfway along a height of the outer chamber.

15. The electric generator of claim 1, wherein the first quantity of water is approximately 75 litres.

16. The electric generator of claim 1, wherein the second quantity of water is approximately 104 litres.

17. The electric generator of claim 1, wherein the counterweight has a weight of between 2 and 5 pounds.

18. The electric generator of claim 1, wherein the at least one return pipe has a diameter of approximately 5 cm.
